(19) United States
(12) Patent Application Publication
(10) Pub. No.: US 2007/0239338 A1
(43) Pub. Date: Oct. 11, 2007

(54) Worksite preparation method using compaction response and mapping information

(76) Inventors: Dean Potts, Maple Grove, MN (US); Paul T. Corcoran, Washington, IL (US); Everett G. Brandt, Brimfield, IL (US); Thomas M. Congdon, Dunlap, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/517,066

(22) Filed: Sep. 7, 2006

Related U.S. Application Data
(63) Continuation-in-part of application No. 11/399,174, filed on Apr. 6, 2006.

(51) Int. Cl. G06F 19/00

(52) U.S. Cl. 701/50

(57) ABSTRACT

A worksite preparation method includes moving a compactor machine across at least one region of a worksite, and sensing values indicative of a compaction response of work material in a compacted region. The method also includes generating a machine traffic plan in real time responsive to the sensed values, outputting control signals corresponding to the machine traffic plan and taking a worksite fill action responsive to the control signals.

### CROSS REFERENCE TO RELATED APPLICATIONS

The present patent application is a continuation-in-part of U.S. patent application Ser. No. 11/399,174.

### TECHNICAL FIELD

The present disclosure relates generally to methods and systems for preparing a worksite such as an earthworks site, and relates more particularly to such a method using compaction response and mapping information in real time computer generation of a worksite traffic plan.

### BACKGROUND

Most construction, road building and other earthworks endeavors require relatively extensive preparation procedures to ensure proper load bearing capacity, elevation, contouring and other characteristics of a worksite. It is typically necessary to import, or at least redistribute, work material fill at the site to achieve these goals. In conventional practice, one or more compactor machines are used to compact the site while additional fill material is delivered via trucks and/or redistributed with graders, tractors, etc. It is further common for compactors to compact successively deposited layers of earthen fill until a desired fill state in a particular region has been achieved. Once the site is filled and compacted as desired, construction of a road, parking lot, building, earthen or other structure may take place.

The aforementioned project types often take place at relatively large worksites, where there may be some natural variation in the topography and soil mechanics across the site. Moreover, the worksite design may call for variation in the elevation, or variations among the compaction specifications among different regions of the worksite having different intended end uses such as parking lots versus large buildings. It will be readily apparent that work planning at many worksites may quickly become relatively complex to account for such factors. One or more compactors may be operating in different areas of the site, while one or more hauling trucks are delivering fill loads. Variations in the soil type and moisture content of fill loads can further complicate matters. A foreman is thus often tasked with directing complex traffic patterns at the worksite to avoid undue delays, deposition of earthen fill in the wrong regions, and overall wasted effort by the compactors and other machines.

While certain persons can develop significant skill and intuition based on extensive project management experience, human observation and awareness have their limitations and sub-optimal work, or re-work at a site to correct errors, is common. For instance, reliance upon a site manager's best guess can lead to deposition of work material fill in the wrong place or at the wrong lift thickness, or where the underlying fill is not yet optimally prepared in terms of moisture content or other characteristics. Operation of heavy equipment at worksites tends to be quite expensive, and thus errors in judgment and human perception can be costly.

In an attempt to improve the efficiency of worksite preparation and planning, various strategies for monitoring and measuring the progress of machines at worksites have been developed, particularly with respect to determining compactor coverage of a work area. Many such strategies assume a certain correlation between compactor coverage and compaction state, however, which may not always be true. While such approaches represent improvements over reliance upon mere guesswork or operator perception, there is room for improvement.

The present disclosure is directed to one or more of the problems or shortcomings set forth above.

### SUMMARY OF THE INVENTION

In one aspect, the present disclosure provides a method of preparing a worksite. The method includes moving a compactor machine across at least one region of the worksite, sensing values indicative of a compaction response of a work material in at least one region of the worksite, and generating a machine traffic plan for the worksite responsive to the sensed values at least in part via an electronic controller of the compactor machine.

In another aspect, the present disclosure provides a method of preparing a worksite, including moving a compactor machine across at least one region of the worksite, and determining a work material compaction response associated with at least one region of the worksite. The method further includes generating a signal associated with the compaction response of the at least one region, receiving the generated signal with a machine different from the compactor machine, and taking a work material fill action at the worksite responsive to the signal with a machine different from the compactor machine.

In still another aspect, the present disclosure provides a worksite preparation system, including a compactor machine and at least one sensor configured to sense parameter values indicative of a work material compaction response in a region of the worksite. The system further includes at least one electronic controller coupled with the at least one sensor and configured via a worksite fill planning control algorithm to generate a worksite traffic plan control signal responsive to the sensed parameter values.

### BRIEF DESCRIPTION OF THE DRAWINGS

FIG. 1 is a side diagrammatic view of a compactor machine suitable for use in one embodiment of the present disclosure;

FIG. 2 is a schematic illustration of a representative worksite model and portions of a worksite preparation system according to one embodiment of the present disclosure; and

FIG. 3 is a flowchart illustrating an exemplary control process according to one embodiment of the present disclosure.

### DETAILED DESCRIPTION

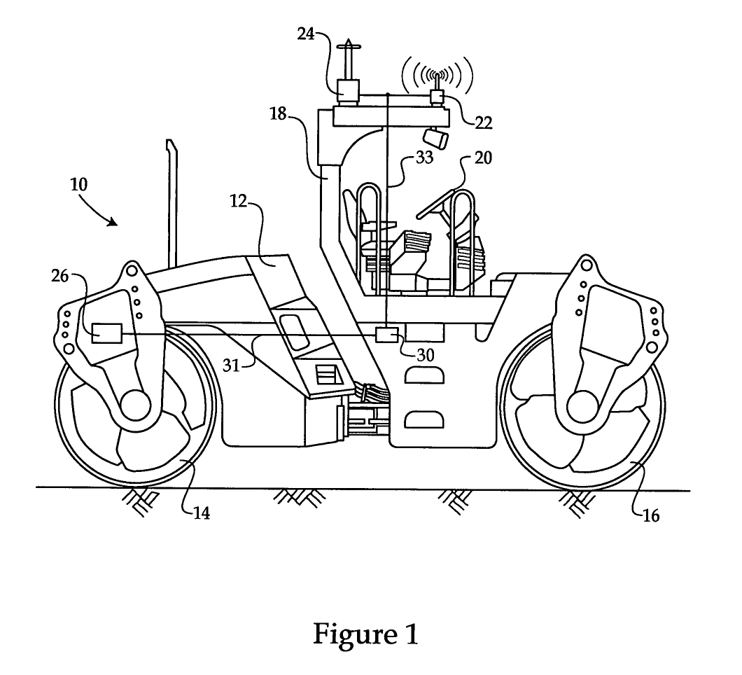

Referring to FIG. 1, there is shown a compactor machine 10 including a frame 12 having a first rotating compacting unit 14 and a second rotating compacting unit 16 mounted thereto. Compactor machine 10 may further include an operator cabin 18 and an operator steering input device 20 positioned therein. A signal transmitter 22 and signal receiver 24 are mounted on frame 12 and are coupled with an electronic controller 30 via one or more communication lines 33. At least one sensor 26 may be mounted to compactor machine 10 and configured to sense values indicative of a work material compaction response, as described herein, and is in communication with electronic controller 30 via another communication line 31. While compactor machine 10 is shown in the context of a machine having dual rotating drums 14 and 16, the present disclosure is not thereby limited, and other types of compacting machines may be suitable for use in the context of the present disclosure. For instance, a belted compactor or a compactor having a single rotating compacting unit, or more than two compacting units, might be used. Rather than a self-propelled compactor machine as shown, compactor machine 10 might be a tow-behind or pushed unit configured to couple with a tractor, for example. A landfill compactor, or still other compactor types, may also be fairly considered to fall within the scope of the present disclosure.

The at least one sensor 26 may be a sensor or a set of sensors configured to sense a relative rolling resistance of compactor machine 10 as it moves across work material at a worksite, and output sensed values to electronic controller 30. It should be appreciated that the term “work material” should be broadly construed herein, as the teachings of the present disclosure are considered to be generally applicable to most, if not all work material types. Moreover, descriptions herein of “soil” or “earth” should not be construed in a limiting sense. Soil, sand, gravel, concrete, asphalt, landfill trash, mixtures including any of the foregoing, etc., are all contemplated as work materials suitable for use in worksite preparation via the methods and apparatuses described herein.

Sensed rolling resistance may in turn indicate a relative compaction state of work material across which compactor machine 10 is moved. Relative compaction state relates to load bearing capacity of the compacted work material which will often, although not necessarily, be the parameter of most interest to operators and project managers. In some jurisdictions, compaction state is judged by a density measurement, for example, and it should thus be appreciated that the compaction state and parameter values of interest are not limited to the embodiments specifically described herein. Sensor 26 may thus be any of a variety of sensor types, or sensor groups, so long as it is configured to sense some parameter value that is indicative of, either directly or indirectly, a compaction response of work material at a worksite, as described herein. While it is contemplated that mounting sensor 26 on compactor machine 10 will provide one practical implementation strategy, the present disclosure is not thereby limited, and one or more sensors could be used which are separate from compactor machine 10.

In the context of relative rolling resistance, as compactor machine 10 moves across a region of work material, the energy necessary to propel compactor machine 10 is generally inversely proportional to the relative degree of load bearing capacity of the region of the worksite across which compactor machine 10 is passed. This phenomenon is similar to the familiar relationship between the relatively greater effort needed to roll a wheel across a relatively soft substrate like sand as compared to a relatively harder substrate like concrete. As the substrate, in the present case the work material being compacted, becomes relatively stiffer, less energy is required to move the compactor.

Electronic controller 30 may be configured to log rolling resistance values sensed by sensor 26 during each of a plurality of compactor passes over a region of a worksite to determine a work material compaction response associated therewith. One specific means for determining the rolling resistance may include determining gross driveline energy in compactor machine 10, subtracting the internal losses of the machine, and further subtracting the portion of energy expended that relates to an inclination of the work surface in the particular region of interest. This calculation allows a determination of the net energy expended to compact the work material to a given compaction state, or “net compaction energy,” which is in turn indicative of the work material compaction response. In such an embodiment, sensor 26 may comprise one or more sensors, including for example a ground speed sensor and an inclinometer, configured to sense operating parameters that allow electronic controller 30 to calculate the net compaction energy. A suitable apparatus and method for this purpose is disclosed in U.S. Pat. No. 6,188,942 to Corcoran et al. Those skilled in the art will appreciate that various other means are available for directly or indirectly determining the net compaction energy imparted to the work material by compactor machine 10, or some other compaction state parameter of interest. For instance, rolling resistance of a hydrostatic drive compactor machine may also be used, albeit via a slightly different approach. In a hydrostatic drive machine, rolling resistance may be computed, for example, based on sensed hydraulic pressure and flow rate to give an indication of the amount of machine energy imparted to the work material.

Alternatively, where work material density is monitored, a density sensor, for example, utilizing radiation backscatter or electromagnetic waves, may be used. Troxler Electronic Laboratories, of Research Triangle Park, North Carolina is one commercial source for suitable density measuring devices. In still further embodiments, other parameters such as fuel consumption may be used in determining the net energy required to pass compactor machine 10 across the work surface and, hence, indicate the relative compaction state and ultimately work material compaction response. In further embodiments, traditional walk out tests for density, or measurements of the depth of penetration of a tow behind device can be used to assess relative compaction. In still further embodiments, a relative rolling radius strategy may be used, or possibly known techniques for quantifying a sinkage deformation interaction between compactor machine 10 and the work material. Yet another measure of relative compaction state which may be applied in the present context is elevation of a particular region of a worksite. Global and local positioning systems may be used to provide an indication of a relative elevation of compactor 10. Relative elevation data may be compared with previously recorded elevation data or expected data to determine, for example, if a fill load has been placed and/or placed at an appropriate lift thickness. Where a fill load has not been placed, or has been deposited at an inappropriate thickness, machine traffic at the site, including moving compactor 10, may be directed accordingly, as described herein. The present disclosure contemplates any compaction state measurement strategy known in the art.

Compactor machine 10 may also receive position signals via signal receiver 24 to allow determination of the relative position of compactor machine 10 within a worksite. The position signals may be, for example, signals received directly or indirectly from global positioning system (“GPS”) satellites, or some other sort of position signal such as a ground based laser positioning signal. Rather than receipt of position signals by compactor machine 10, a remotely positioned computer might instead receive transmitted position signals from compactor machine 10 and thereby determine its relative position. Compactor machine 10 will also typically be equipped with a transmitter 22 configured to output control signals, position signals or other signals to one or more receivers and computers positioned remotely from compactor machine 10 which is configured to take an action responsive to the signals, as described herein. The remote receiver and computer may include, for example, receivers associated one with each of a plurality of other earthworks machines. The remote receiver and computer might also be located at a site management office, as certain of the operations of the present disclosure may be carried out at a site management office via computer, or a project manager or technician if desired. Determination of the relative position of compactor machine 10 within a worksite, and determination of a work material compaction response, will allow a determination of compaction progress, or lack thereof, to be associated with particular regions of a worksite, in real time.

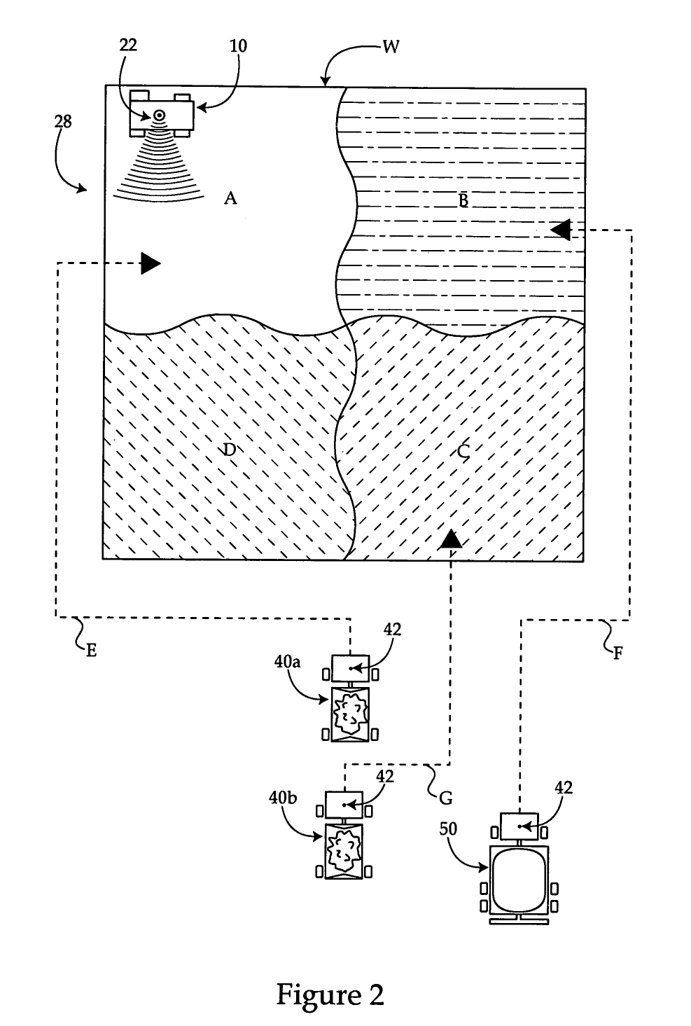

Turning also to FIG. 2, there is shown a schematic illustration of a worksite W divided into regions, A, B, C and D. A worksite preparation system 28 that includes compactor machine 10 and may include other machines is also shown. System 28 may include first and second machines such as a first hauling truck 40a and a second hauling truck 40b, shown in relation to worksite W, and also a third machine such as a water truck 50, for example. Hauling trucks 40a and 40b are contemplated to be used in delivering work material fill loads to selected regions of worksite W. In many worksite preparation processes, earth or another fill material is delivered from a remote site to provide the fill necessary for raising, leveling or otherwise contouring worksite W. In certain instances, a specific work material type may be called for which is available only by delivering it to worksite W from elsewhere. Thus, one or more hauling trucks such as trucks 40a and 40b may be employed to deliver work material fill loads to worksite W as needed. Work material fill may also be moved about a single site, for example, where it is desirable to level some or all of a given worksite having relatively higher elevation areas and relatively lower elevation areas, and also having readily movable, suitable fill. It will also be typically desirable to spread deposited fill loads at the worksite. To this end, system 28 may also include other machines for moving and distributing work material to or from, or within, site W such as scraper machines, motor graders, tractors equipped with dozing blades, etc.

Water truck 50 is contemplated to be used in applying water or a water-containing fluid such as a soil conditioning fluid to selected regions of worksite W needing the addition of moisture. It is thus contemplated that water may be applied to overly dry soil detected as described herein, as a remedial measure to prepare soil in a particular region for compaction or other treatments. It should be appreciated, however, that a different machine may be used where the soil condition differs. For example, for overly wet soils, truck 50 might instead comprise a tractor equipped with a disk or similar implement for conditioning soil to accelerate natural drying. A lime dispensing truck might also be used in certain cases. It is contemplated that in most embodiments a compactor such as compactor machine 10 and at least one other machine, for either delivering additional fill loads or for remedying defects or otherwise conditioning work material, will be used in system 28. In still other embodiments, machine 50 might comprise a second compactor machine.

Operation of compactor machine 10 to compact worksite W will allow compaction response data to be gathered for each of the regions, typically after a plurality of compactor passes over each of the regions. As alluded to above, during compacting, electronic controller 30 of compactor machine 10 may log position or mapping information such that a compaction response of an identified region may be determined.

In the context of worksite W, electronic controller 30 may be configured to determine a worksite traffic plan responsive to the mapping and compaction response data for regions A, B, C and D and then broadcast a corresponding control signal via transmitter 22 to one or more of machines 40a, 40b and 50, or to one or more different machines or human managers/operators which can communicate the traffic plan accordingly to machines 40a, 40b and 50, as described herein.

Implementation of the above practices and system may be embodied in a method of preparing a worksite according to the present disclosure. The method may include moving compactor machine 10 across at least one region of worksite W, and may further include moving compactor machine 10 across each of regions A, B, C and D via a plurality of preliminary compactor passes. The method may further include sensing values indicative of a compaction response of a work material in the compacted region(s), for example, via sensor 26. Sensor 26 may output the sensed values to an electronic controller such as electronic controller 30, which may in turn determine a work material compaction response associated with each of regions A, B, C and D. Position signals may also be received, for example, by electronic controller 30 from receiver 24. Logging input values from sensor 26 and position signal values received via receiver 24 will enable determination of a work material compaction response that is associated with each one of regions A, B, C and D in real time, and enable planning and directing of traffic at worksite W in a manner not possible via known strategies.

The generated machine traffic plan may be understood as a plan for selectively directing machine traffic at worksite W or dispatching machines at worksite W. For example, the machine traffic plan may include selecting travel routes and deposition regions for work material fill loads via trucks 40a and 40b, and it may also include selecting machines such as machine 50 to dispatch to or within worksite W. The machine traffic plan may also include determining that machines should be re-directed from a previously determined route or region, or that certain operations should be halted, slowed or accelerated. The present disclosure contemplates generating a machine traffic plan responsive to the sensed values and position signals that includes planning essentially any aspect of worksite preparation that relates to machine routing and work material deposition, distribution and/or conditioning. For instance, where it is determined that compactor 10 is at a relative elevation different from a desired or expected elevation and, hence, a problem with material fill has occurred which is reflected in the compaction response data, the planned route for compactor 10 may be adjusted to allow remediation or further fill.

Generating the machine traffic plan may also include generating, for example broadcasting, a control signal corresponding with the machine traffic plan. In other words, once the plan is generated, control signals may be output from compactor machine 10, another machine, or by a person, which direct the routing, deposition, work material conditioning, etc., that is the subject of the machine traffic plan. The outputted control signal may comprise a machine maneuvering signal, a machine dispatching signal, or some other control signal. Embodiments are contemplated wherein the control signal includes communication with a machine operator, for example, radio communication, or communication with a machine itself. Further embodiments may include commanding autonomous operation and/or routing of a machine at worksite W via the control signal.

The control signal corresponding with the machine traffic plan may be broadcast via transmitter 22, for example, and received via one of machines 40a, 40b, 50, or received via a remote computer or person. The method may further include taking an action such as a worksite fill action responsive to the broadcast control signal. In one embodiment, taking a worksite fill action may include selectively depositing a work material fill load at the worksite responsive to the control signal. In particular, selectively depositing a work material fill load may include depositing a work material fill load at a first region, if the compaction response associated with the first region is a target compaction response and the region is not yet at a desired state such as a desired fill state. In other words, where work material in a particular region of worksite W is compacting satisfactorily, or has compacted to a target compaction state, a work material fill load may be selectively deposited there, if more work material fill is required. If instead, for example, target compaction specifications have been met for a particular region, and the region has received a desired amount or elevation of fill, the work material fill load may be deposited at a different region. Further, if the compaction response associated with the first region differs from a target compaction response, regardless of fill state, it may be determined that fill should not yet be placed at the region, if at all, and should instead by deposited at a different region. Position signals received via receiver 24 may be used in certain instances to determine a three-dimensional location of compactor machine 10 which can indicate whether a desired elevation or fill state of a particular region has been achieved.

The determined compaction response associated with a given region may also indicate the appropriate thickness of the work material lift at that region. To this end, selective deposition of work material fill at the region may also include controlling a lift thickness of the work material fill load that is deposited at a selected region. In general terms, greater lift thickness is associated with fewer work material loads, as layers deposited at thicker lifts will include more total material and, hence, may require relatively fewer loads to reach a desired lift state. As lift thickness increases, however, it may become more difficult to reach target compaction in a given region. Hence, where excess lift thickness of a particular lift is detected in a given region, it may be determined that subsequent work material fill loads should be deposited at relatively thinner lift thicknesses. Accordingly, the method may also include generating a lift thickness deposition signal, and taking a work material fill action may include depositing a work material fill load at a desired lift thickness responsive to the lift thickness deposition signal. An exemplary means for determining inappropriateness of lift thickness is taught in co-pending U.S. patent application Ser. No. 11/399,174, of which the present application is a continuation-in-part, now U.S. Pat. No. ______.

The method of the present disclosure may also include determining a moisture condition of at least one region of worksite W based on the compaction response thereof. Generation of the machine traffic plan may include generating the traffic plan responsive to the determined moisture condition, if the condition is an undesired moisture condition such as excess moisture or insufficient moisture. It is recognized in the art that excessive moisture, as well as insufficient moisture, in a work material fill may affect the ability to satisfactorily compact material in a particular region. The control signal corresponding to the machine traffic plan may include a dispatching control signal which may be received by truck 50, or for example a disc-equipped tractor, to dispatch truck 50 to a selected region of worksite W for adjusting the moisture condition thereof.

Still other compaction response characteristics may be used in generating the machine traffic plan, for instance, overcompaction or generally unfit compaction responses, may also be identified and the corresponding regions of worksite W selected for remediation, fill deposition to those regions suspended, etc. Exemplary methods of determining the presence of such aberrant compaction responses is also taught in the parent application of the present application.

While the presently described method contemplates dividing worksite W into a plurality of regions, it should be appreciated that the present disclosure is not thereby limited. For example, worksite W may include one, two, three, or more than four regions. In an embodiment where worksite W is evaluated as a single region, position signals may not be necessary in determining a work material compaction response. In other words, because the entire worksite W is the region of interest, an association between compaction response and relative location may be unnecessary. In such an embodiment, the machine traffic plan may consist of determining whether and when any support machines are to be operated at the worksite. A division, if any, of the worksite into regions could change in real time as worksite conditions change.

To collect the data used in determining a compaction response, generating a traffic plan and broadcasting a corresponding control signal, it will typically be desirable to pass compactor machine 10 over each of regions A, B, C and D via a plurality of preliminary passes, each time collecting compaction response data via sensor 26. At least two, typically three or four, compactor passes may be necessary to gather sufficient data. Compaction response data may be subsequently used to plot a compaction response curve for each of regions A, B, C and D. The determined compaction response curve may then be compared with a desired compaction response curve, for example corresponding data points on two curves compared, and the aforementioned conditions such as target compaction, moisture condition, appropriateness of lift thickness, etc. determined responsive to the comparison.

For instance, work material having too much moisture may, for certain material types, exhibit a relatively shallow, as opposed to steep, initial slope of its compaction response curve where load bearing capacity or net energy is plotted versus compactor pass number. For overly dry work materials, the corresponding portion of a similarly plotted compaction response curve may appear relatively steep. Where work material density is plotted versus compactor pass number these relationships regarding compaction response curve slopes may be reversed. Other conditions which may be indicated by an initial slope of a compaction response curve may include cohesionless or low-cohesive work materials such as dry sands. Slopes of portions of a compaction response curve may be calculated by known linear regression techniques.

In addition to compaction response curve slope, closeness of fit of a compaction response curve to the data points defining the curve may indicate certain compaction conditions. Poor closeness of fit may be indicative of overcompaction, the presence of foreign objects in the fill, inappropriate lift thickness or unsuitable soil type, for example. Closeness of fit may be quantified by a sum of errors relating data points which define a curve fitted compaction response curve with corresponding points on the curve. Still further features of the compaction response curves that may indicate certain conditions of the work material may include a predicted or determined asymptotic level of energy or load bearing capacity that is not commensurate with expectations for a given number of compactor passes. Slope, closeness of fit, and other work material compaction response features that are associated with either desired curves, or aberrant curves, may be determined empirically, for example, by compacting test beds of known material types under known conditions. The conditions described above may then be used to evaluate whether a particular region of worksite W is appropriate for deposition of an additional work material fill load via truck 40a, 40b, or whether remediation or other treatment is desirable via water truck 50, or some other machine. Determination of compaction response curves and comparison of compaction response data points therewith may also occur, for example, as taught in the parent application of the present application.

Once a machine traffic plan has been generated, and actions taken responsive thereto, compactor machine 10 may be moved across one or more of regions A, B, C and D via one or more subsequent passes. In certain cases, refinement of the compaction response(s) associated with the one or more regions may indicate that a different machine traffic plan is appropriate. In other words, the machine traffic plan initially determined may be updated based on additional compaction response data following the preliminary passes. A region initially determined to be compacting or responding in an aberrant manner might in fact be subsequently determined to have an acceptable compaction response. The converse is also possible, wherein an aberrant compaction response might not become evident until the subsequent set of compactor passes. In such an embodiment, a second machine traffic plan that differs from the first plan may be generated and executed as described herein.

As alluded to above, each of a plurality of worksite regions may exhibit differing compaction responses, and may call for different actions to be taken with respect to a particular region. Electronic controller 30 may thus be configured to determine a machine traffic plan, and generate a corresponding signal(s), that relates to multiple regions of worksite W. In FIG. 2 each of regions A, B, C and D is illustrated in different patterns. In the illustrated example, region A is shown without dashes, corresponding to a first condition. Region A may be determined to have the first condition, for example, a target compaction condition but not yet at a desired fill state, and therefore ready to receive another work material fill load. As such, electronic controller 30 may command a signal be transmitted via transmitter 22 indicating that a work material fill load is to be deposited in region A. An operator or electronic controller of truck 40a, for example, may be alerted that the fill load carried by truck 40a is to be deposited at region A, and a route E for truck 40a selected. Directing truck 40a as described may consist of either a re-direction from a different region selected as a default fill load deposition region, or directing truck 40a might serve as a confirmation signal that Region A is indeed an appropriate region for deposition of the fill load.

Region C, illustrated with a diagonal dashes in a first orientation, might be determined to be in a condition similar to that of Region A, compacting generally as desired, however, the compaction response associated with Region C may call for deposition of work material at a specific lift thickness. Truck 40b may thus be routed along route G and commanded to deposit its fill load at Region C at the prescribed lift thickness responsive to the control signal corresponding with the machine traffic plan.

Region B, illustrated with horizontal dashes, may exhibit yet a different condition, such as an insufficient moisture condition and, hence, a machine dispatching signal may be generated which is received by truck 50. The machine dispatching signal may indicate that water is to be applied to Region B. Truck 50 may be dispatched responsive to the dispatching signal as shown, along route F.

Region D, shown with diagonal dashes in a second orientation, may exhibit yet another condition. For example, Region D may have reached target compaction and also a desired fill state, and hence no remediation or deposition of a fill load is necessary.

In the foregoing manner, the present disclosure may be understood as providing means for monitoring compaction progress at a worksite and optimally planning supporting machine traffic. While a single compactor machine might be grouped with a plurality of haul trucks, one tractor, one water truck, etc., the present disclosure is not thereby limited, and any combination and numbers of the machines described herein may represent a system suitable for use in the context of the present disclosure. Moreover, the present disclosure also contemplates operation of more than one compactor machine, and integration of the machine traffic plans generated by each of a plurality of compactor machines such that optimal deposition and conditioning of work material at a worksite is possible. For example, a second compactor (not shown) might be operated at worksite W of FIG. 2, and configured in a manner similar to that of compactor machine 10 such that work material compaction response values are sensed during moving the second compactor machine across the worksite. Where the second compactor is maneuvered to follow behind compactor machine 10, for example, its evaluation of the compaction response of work material in each of the regions might be used to update and/or refine compaction response data gathered via compactor machine 10, and the machine traffic plan generated or modified accordingly.

Electronic controller 30 may be configured via a worksite fill planning control algorithm to generate a control signal corresponding with the machine traffic plan, responsive to the parameter values sensed via sensor 26. To this end, electronic controller 30 may include a computer readable medium such as RAM or ROM, or another medium, having the control algorithm electronically, magnetically, etc. stored thereon. Hardware components configured to perform certain of the functions carried out by the control algorithm rather than a purely software based system may also be provided. The control algorithm may further include means for determining conditions of the work material such as excess moisture, insufficient moisture, lift thickness, target compaction conditions, etc. for the various regions of a worksite.

### INDUSTRIAL APPLICABILITY

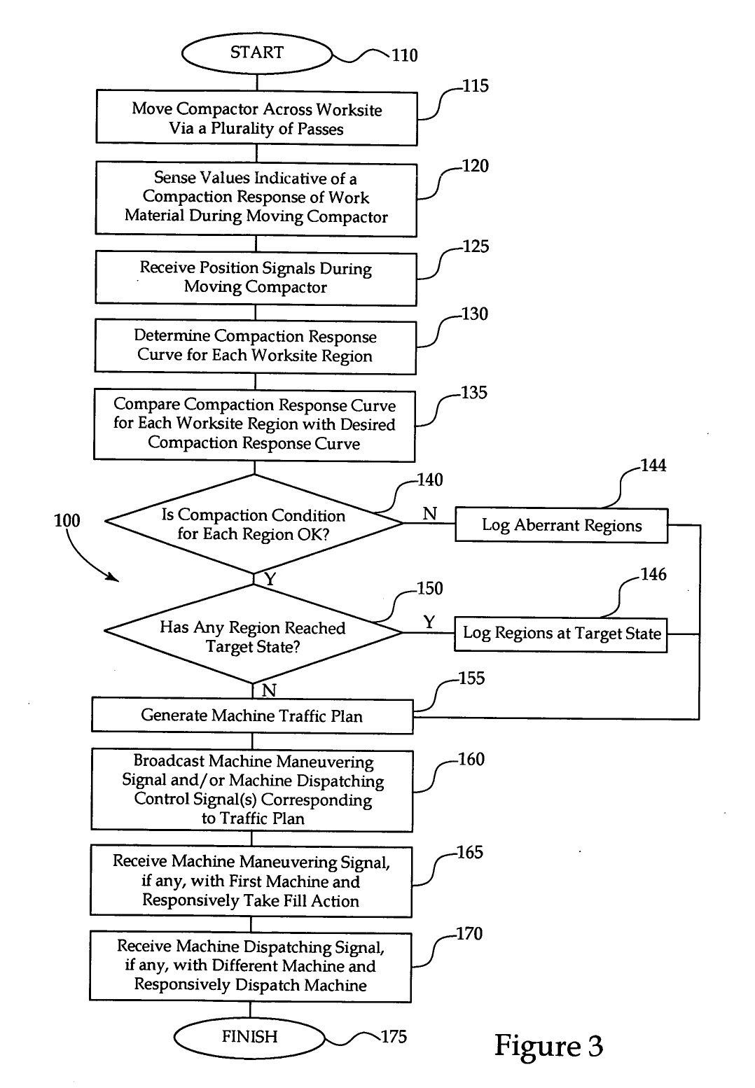

Turning to FIG. 3, there is shown an exemplary control process 100 by way of a flowchart according to one embodiment of the present disclosure. It should be appreciated that process 100, or a similar process, may be carried out prior to deposition of any work material fill at a worksite, after non-uniform work material deposition, at some regions and not others, or after uniform deposition of work material at all regions of the worksite. Process 100 may begin at a START, or initialize Step, 110, and may thenceforth proceed to Step 115 wherein compactor machine 10 is moved across at least one region of a worksite such as worksite W via a plurality of passes.

From Step 115, the process may proceed to Step 120 wherein values indicative of a compaction response of work material may be sensed during moving compactor machine 10. From Step 120, the process may proceed to Step 125 wherein position signals are received via receiver 24. Continuous or repetitive receipt of position signals, and continuous or repetitive sensing of values indicative of compaction response will allow electronic controller 30 or a different electronic controller, possibly positioned remotely, to determine a compaction response that is associated with each of the defined regions A, B, C and D. Each of Steps 115, 120 and 125 is illustrated as a discrete step in process 100 for clarity; however, it should be appreciated that the processes may be taking place simultaneously.

From Step 125, process 100 may proceed to Step 130 wherein electronic controller 30 may determine a compaction response curve associated with each of regions A, B, C and D. From Step 130, the process may proceed to Step 135 wherein electronic controller 30 may compare the determined compaction response curve for each of regions A, B, C and D with a desired compaction response curve. In certain worksites, it will be desirable to compact all of the regions of the worksite to a uniform compaction state. The present disclosure is not thereby limited, however, as in some instances the compaction specifications for different regions of the work site may differ, for example, where one region is to be used as a parking lot and another region as an earthen retaining pond. Different work material types might also be used within one worksite, either by design or because of availability, and thus each might have a different “desired” compaction response. Thus, while in one embodiment the desired compaction response curve with which the determined compaction response curve for each region is compared may be the same, in other embodiments, different regions could have different “desired” compaction response curves.

From Step 135, the process may proceed to Step 140 wherein electronic controller 30 may query whether the compaction condition of each of regions A, B, C and D is OK. In other words, at Step 140, electronic controller 30 may determine whether each of the regions is compacting or has compacted as desired. If the compaction response of a particular region is determined to be aberrant, that is, different from a desired compaction response, then the process may proceed to Step 144 wherein electronic controller 30 may log that region as aberrant. If each of the regions of worksite W is compacting as desired, process 100 may proceed from Step 140 to Step 150 wherein electronic controller 30 may query whether any region has reached a target state such as a target compaction state or a target fill state. If any of the regions has reached a target state, the process may proceed to Step 146 wherein electronic controller 30 may log that region as being at a target state. It should be appreciated that a “target state” as described herein may be either of a target fill state, such that the respective region does not need additional material, or it could be a target compaction state, meaning that a lift of deposited work material fill has been compacted to a desired state, and is ready for an additional lift to be added.

If at Step 150 none of the regions has reached a target state, the process may proceed to Step 155 wherein electronic controller 30 may generate the machine traffic plan, as described herein. Generation of the machine traffic plan may account for regions logged as aberrant, needing some remediation or the passage of time, as well as accounting for regions that do not need additional work material fill. Thus, in generating the machine traffic plan electronic controller 30 will typically select a deposition region which is compacting as desired, and is ready for additional fill. Electronic controller 30 may also select a region for remediation. If none of the regions of the worksite evidences a target state or an aberrant state, generation of the machine traffic plan may take place via a default fill plan, or in certain embodiments, a deposition region for additional fill loads may be selected by an operator or site manager.

From Step 155, process 100 may proceed to Step 160 wherein the control signal(s) corresponding to the machine traffic plan are broadcast, including for example a machine maneuvering signal and/or a machine dispatching signal. Process 100 may thenceforth proceed to Step 165, wherein the machine maneuvering signal, if any, may be received and acted upon by a machine different from compactor machine 10. Process 100 may then proceed to Step 170 wherein the machine dispatching signal, if any, may be received by yet another machine and acted upon, for example by dispatching the machine. Process 100 will thenceforth proceed to Step 175, to FINISH.

Control processes according to the present disclosure contemplate communication among several machines, and the execution of a relatively sophisticated machine traffic plan, with several actions occurring simultaneously. It should be appreciated, however, that alternative embodiments are contemplated. Rather than the machine traffic plan consisting of signals directing fill load traffic to a particular area, and signals directing remedial machines to perform specific tasks, in more rudimentary embodiments, the machine traffic plan and associated control signal might consist only of a “Fill Here” signal, if conditions call for deposition of an additional fill load at a particular area. On the other hand, if conditions are not appropriate for deposition of an additional fill load in region A, the signal might be “Do Not Fill Here” or something similar. In certain embodiments, the signaling may consist of radio communications between operators and/or project managers, who are privy to data relating to work material compaction response and relative compactor position as described herein.

The present disclosure provides for substantially improved planning and directing of machine traffic at worksites. Reliance upon subjective determinations by project managers as to the appropriate places to deposit, or not deposit, work material fill is reduced or eliminated. Moreover, the ability to determine moisture condition and appropriate lift thickness in real time can prevent the incorrect or untimely placement of work material fill, and allow dispatching of machines such as water trucks, lime applicators and disk-equipped tractors where needed.

The present description is for illustrative purposes only, and should not be construed to narrow the breadth of the present disclosure in any way. Thus, those skilled in the art will appreciate that various modifications might be made to the presently disclosed embodiments without departing from the full and fair scope of the present disclosure. While the present description discusses the use of one or more electronic controllers mounted on compactor machine 10, it should be appreciated that the present disclosure is not thereby limited. Embodiments are contemplated wherein compactor machine 10 is equipped with a sensor such as sensor 26, and also configured to output signals to a remote electronic controller which is configured to actually generate the machine traffic plan at worksite W. In still other embodiments, sensing of the values indicative of a work material compaction response could be carried out via sensing equipment that is altogether separate from compactor machine 10, and compaction response data communicated to a remote electronic controller apart from compactor machine 10. In such an embodiment, compactor machine 10 would serve to compact the work material, but might otherwise have little, if anything, to do with generating a machine traffic plan and/or taking action responsive thereto. Other aspects, features and advantages will be apparent upon an examination of the attached drawings and appended claims.

What is claimed is:

1. A method of preparing a worksite comprising the steps of:
moving a compactor machine across at least one region of the worksite;
sensing values indicative of a work material compaction response in at least one region of the worksite; and
generating a machine traffic plan for the worksite responsive to the sensed values at least in part via an electronic controller of the compactor machine.

2. The method of claim 1 further comprising a step of broadcasting a control signal corresponding to the machine traffic plan from the compactor machine.

3. The method of claim 2 further comprising a step of taking a worksite fill action responsive to the broadcast control signal, including a step of selectively depositing a work material fill load at the worksite responsive to the control signal.

4. The method of claim 3 further comprising the steps of:
receiving position signals indicative of a relative position of the compactor machine within the work area; and
determining a work material compaction response associated with each one of a plurality of regions of the worksite responsive to the position signals and sensed values.

5. The method of claim 4 wherein the step of selectively depositing a work material fill load further comprises:
depositing a work material fill load at a first region, if the compaction response associated with the first region is a target compaction response and the region is not at a desired fill state; and
depositing a work material fill load at a region different from the first region, if the compaction response associated with the first region differs from a target compaction response.

6. The method of claim 5 wherein the step of selectively depositing a work material fill load further comprises depositing a work material fill load at a region different from the first region, if the determined compaction response of the first region is a target compaction response and the first region is at a desired fill state.

7. The method of claim 4 wherein the step of selectively depositing a work material fill load comprises controlling a lift thickness of the fill load based at least in part on a compaction response of work material in a selected region.

8. The method of claim 2 further comprising a step of determining a moisture condition of at least one region of the worksite responsive to the sensed values, wherein the generating step comprises generating the machine traffic plan responsive to the determined moisture condition, if the determined moisture condition is an undesired moisture condition.

9. The method of claim 8 wherein the broadcasting step includes broadcasting a machine dispatching control signal responsive to an undesired moisture condition, the method further comprising a step of receiving the machine dispatching control signal with a machine separate from the compactor machine and responsively adjusting a moisture condition of the at least one region.

10. The method of claim 1 wherein moving the compactor machine across the at least one region includes moving the compactor machine across the at least one region via a plurality of preliminary passes, the method further comprising the steps of moving the compactor machine across the at least one region via a plurality of subsequent passes, sensing values indicative of a work material compaction response in the at least one region during the plurality of subsequent passes, and generating a different machine traffic plan for the worksite responsive to the values sensed during the subsequent passes.

11. A method of preparing a worksite comprising the steps of:
moving a compactor machine across at least one region of the worksite;
determining a work material compaction response associated with at least one region of the worksite;
generating a signal associated with the compaction response of the at least one region;
receiving the generated signal with a machine different from the compactor machine; and
taking a work material fill action at the worksite responsive to the signal with a machine different from the compactor machine.

12. The method of claim 11 wherein the step of determining a compaction response includes determining a compaction response of a work material in each one of a plurality of regions of the worksite, and wherein the step of taking a work material fill action comprises a step of selecting one of the plurality of regions for deposition of a work material fill load.

13. The method of claim 12 further comprising a step of receiving position signals indicative of a relative position of the compactor machine within the work area, wherein the determining step includes sensing values indicative of work material relative compaction with at least one sensor of the compactor machine, and determining a compaction response associated with each one of the respective regions based at least in part on the position signals and the sensed values.

14. The method of claim 13 further comprising a step of generating a machine traffic plan for the worksite responsive to the determined compaction response associated with each one of the respective regions of the worksite.

15. The method of claim 14 wherein the step of generating a signal comprises generating a machine maneuvering control signal according to the machine traffic plan, and the receiving step comprises receiving the machine maneuvering control signal with a machine configured to transport and deposit a work material fill load at the worksite.

16. The method of claim 15 comprising a step of generating a lift thickness deposition signal, wherein the step of taking an action comprises depositing a work material fill load at a desired lift thickness at the worksite responsive to the lift thickness deposition signal.

17. The method of claim 14 wherein the step of generating a signal comprises generating a machine dispatching control signal according to the machine traffic plan, and the receiving step comprises receiving the dispatching control signal with a machine configured to adjust a work material moisture condition at the worksite.

18. A worksite preparation system comprising:
a compactor machine;
at least one sensor configured to sense parameter values indicative of a work material compaction response in a region of the worksite; and
at least one electronic controller coupled with the at least one sensor and configured via a worksite fill planning control algorithm to generate a machine traffic plan control signal responsive to the sensed parameter values.

19. The worksite preparation system of claim 18 wherein the at least one sensor comprises a sensor of the compactor machine configured to sense values indicative of relative compaction of the work material during a compactor pass across a region of the worksite, and wherein the at least one electronic controller includes an electronic controller mounted on the compactor machine and configured to broadcast the worksite traffic plan control signal from the compactor machine.

20. The worksite preparation system of claim 19 wherein the at least one electronic controller is configured via the fill planning control algorithm to determine at least one of, an excess moisture condition, an insufficient moisture condition, a lift thickness condition and a target compaction condition of a selected region of the worksite, and further configured to generate said worksite traffic plan control signal responsive to a determined condition.
